(19) United States
(12) Patent Application Publication
(10) Pub. No.: US 2022/0108079 A1
(43) Pub. Date: Apr. 7, 2022

(54) Application-Specific Generated Chatbot

(71) Applicant: SAP SE, Walldorf (DE)

(72) Inventor: Pablo Roisman, Palo Alto, CA (US)

(21) Appl. No.: 17/064,445

(22) Filed: Oct. 6, 2020

(51) Int. Cl. G06F 40/35; G06N 20/00; G06K 9/62; G06F 40/42; G06F 40/154; H04L 12/58

(52) U.S. Cl. CPC G06F 40/35; G06N 20/00; H04L 51/02; G06F 40/42; G06F 40/154; G06K 9/6257

(57) ABSTRACT

A computer implemented system and method of generating chatbots. The system uses a machine learning model to identify elements on the webpage. The system associates intents with the elements, and associates expressions and skills related to the intent. The system generates a chatbot according to the intents, expressions and skills.

### CROSS REFERENCE TO RELATED APPLICATIONS

Not applicable.

### BACKGROUND

The present invention relates to chatbot development, and in particular, to improving the efficiency of the chatbot development process.

Internet protocol (IP) allows the creation and consumption of various application programming interfaces (APIs) in a simple and standard way. An end-user can interact with IP (or other networking protocols) using dedicated chatbots, which are computer programs, possibly containing artificial intelligence (AI) or machine-leading that can perform conversational-type functions (for example, using text or auditory methods). In some cases, chatbots are also known as chat robots, interactive agents, conversational interfaces, smartbots, talkbots, chatterbots, artificial conversational entities, etc.; the general term “conversational AI” may be used). Developing a dedicated chatbot (that is, to perform a specific service) requires resources and time even when using a conventional chatbot development platform. Additionally, conventional development of a chatbot also requires developers to maintain and manually adopt changes in underlying service(s) provided by the chatbot.

Unless otherwise indicated herein, the approaches described in this section are not prior art to the claims in this application and are not admitted to be prior art by inclusion in this section.

### SUMMARY

Given the above, a number of issues are presented. One issue with existing systems is the time required to perform the development process. To develop a chatbot for a given webpage, the chatbot developer needs to identify the potential actions that a user may perform, select the appropriate chatbot functionality, and then associate the webpage actions with the chatbot functionality. This process takes time. The development time is increased when a given webpage supports multiple languages (English, German, Japanese, etc.).

There is a need to improve the development process in these situations.

As further described herein, embodiments are directed to using a machine learning model to identify the user interface elements on the webpage.

In one embodiment, a method generates chatbots. The method includes identifying, by a computer system, one or more elements of a markup language file using a machine learning model. For a given element of the one or more elements, the method further includes generating, by the computer system, one or more intents related to the given element. For a given intent of the one or more intents, the method further includes generating, by the computer system, a plurality of expressions related to the given intent and the markup language file; and generating, by the computer system, one or more skills related to the given intent and the markup language file. The method further includes generating, by the computer system, a chatbot according to the one or more intents, the plurality of expressions for each intent of the one or more intents, and the one or more skills for each intent of the one or more intents.

A computer readable medium may store a computer program for controlling a computer to implement one or more steps of the above methods.

A system may implement one or more steps of the above methods, using one or more computer systems (e.g., a server computer, a database system, a client computer, etc.) to perform one or more of the method steps.

The subject matter described in this specification can be implemented to realize one or more of the following advantages. First, an embodiment may improve the development time spent on creating a chatbot for a given webpage. Second, an embodiment may provide improved access to chatbots for differently-abled end users (e.g., blind, deaf, etc.). Third, an embodiment may improve the development time spent on creating multi-language chatbots for multi-language webpages.

The following detailed description and accompanying drawings provide a better understanding of the nature and advantages of the present invention.

### BRIEF DESCRIPTION OF THE DRAWINGS

FIG. 1 is a block diagram of a chatbot development system 100.

FIG. 2 is a flow diagram of a method 200 of generating a chatbot.

FIG. 3 is a flow diagram of a method 300 of training the machine learning model used by the chatbot development system 100 (see FIG. 1).

FIG. 4 is a flow diagram of a method 400 of using a chatbot.

FIG. 5 is a block diagram of an example computer system 500 for implementing various embodiments described above.

FIG. 6 is a block diagram of a cloud computing system 600 for implementing various embodiments described above.

### DETAILED DESCRIPTION

Described herein are techniques for chatbot development. In the following description, for purposes of explanation, numerous examples and specific details are set forth in order to provide a thorough understanding of the systems and methods described herein. It will be evident, however, to one skilled in the art that the present invention as defined by the claims may include some or all of the features in these examples alone or in combination with other features described below, and may further include modifications and equivalents of the features and concepts described herein.

In this document, various methods, processes and procedures are detailed. Although particular steps may be described in a certain order, such order is mainly for convenience and clarity. A particular step may be repeated more than once, may occur before or after other steps (even if those steps are otherwise described in another order), and may occur in parallel with other steps. A second step is required to follow a first step only when the first step must be completed before the second step is begun. Such a situation will be specifically pointed out when not clear from the context.

In this document, the terms “and”, “or” and “and/or” are used. Such terms are to be read as having an inclusive meaning. For example, “A and B” may mean at least the following: “both A and B”, “at least both A and B”. As another example, “A or B” may mean at least the following: “at least A”, “at least B”, “both A and B”, “at least both A and B”. As another example, “A and/or B” may mean at least the following: “A and B”, “A or B”. When an exclusive-or is intended, such will be specifically noted (e.g., “either A or B”, “at most one of A and B”).

In this document, the term “server” is used. In general, a server is a hardware device, and the descriptor “hardware” may be omitted in the discussion of a hardware server. A server may implement or execute a computer program that controls the functionality of the server. Such a computer program may also be referred to functionally as a server, or be described as implementing a server function; however, it is to be understood that the computer program implementing server functionality or controlling the hardware server is more precisely referred to as a “software server”, a “server component”, or a “server computer program”.

In this document, the term “database” is used. In general, a database is a data structure to organize, store, and retrieve large amounts of data easily. A database may also be referred to as a data store. The term database is generally used to refer to a relational database, in which data is stored in the form of tables and the relationship among the data is also stored in the form of tables. A database management system (DBMS) generally refers to a hardware computer system (e.g., persistent memory such as a disk drive or flash drive, volatile memory such as random access memory, a processor, etc.) that implements a database.

In this document, the terms “to store”, “stored” and “storing” are used. In general, these terms may be used to refer to an active verb (e.g., the process of storing, or changing from an un-stored state to a stored state), to a state of being (e.g., the state of being stored), or both. For example, “storing a data record” may be used to describe the process of storing (e.g., the data record transitioning from the un-stored state to the stored state). As another example, “storing a data record” may be used to describe the current state of a data record (e.g., the data record currently exists in the stored state as a result of being previously stored). When only a single interpretation is meant, such meaning will be apparent from the context.

A chatbot can simulate human conversation, or chatting, through artificial intelligence, machine-learning, or other types of computer programs. In some implementations, chatbots permit highly-engaging, conversational experiences through voice and text that can be customized for use on chat platforms (such as, mobile devices or web browsers executing software applications, and including, but not limited to, Facebook Messenger™ applications, Slack™ applications, Skype™ applications, WhatsApp™ applications, etc.). With the advent of deep/machine-learning technologies (such as text-to-speech, automatic speech recognition, and natural language processing), chatbots that simulate human conversation and dialogue can be leveraged in call center and customer service workflows, development operations management, and as personal assistants.

Different business rules for use with chatbots can be generated (for example, based on government regulations, industry standards, or policies of an individual enterprise). As a particular example, a hotel may set forth rules for operations that relate to hotel room reservations (such as, making a new hotel room reservation or canceling an existing hotel room reservation). In some cases, business rules transmitted through networks are required to conform to one or more web protocols. For example, Open Data Protocol (OData) is a web protocol for querying and updating data over a network. OData permits a user to request data from a data source using the Hypertext Transfer Protocol (HTTP) and to receive results from the data source in various formats (such as, Atom Publishing Protocol (ATOM), JavaScript Object Notation (JSON), or eXtensible Markup Language (XML); these data sources may be generally referred to as markup language files). OData is increasingly used by various computing platforms, such as mobile devices and desktop computers, and is becoming an important method of accessing information over networks. Internet protocols such as OData allow the creation and consumption of REpresentational State Transfer (REST, often referred to as REST-ful) application programming interfaces (APIs) in a simple and standard way, for example, through dedicated chatbots. As in the prior example, a user may wish to generate a new hotel room reservation or to cancel an existing hotel room reservation through interaction with a customer service chatbot, which can reduce overall costs required if actual human interventions are used.

However, developing dedicated chatbots usually requires resources and time even when using conventional chatbot development platforms (such as SAP Conversational AI or other chatbot development platforms). Further, maintenance and adoption of changes in underlying REST services associated with of developed chatbots also requires great expenditure of development resources. For example, in some computing platforms, there can be an ever-increasing number of available applications. If all the available applications are based on OData, it can take about one day to generate a chatbot for each OData-based service. That is, in this example, creating a chatbot for each available application could take approximately 1,000 days.

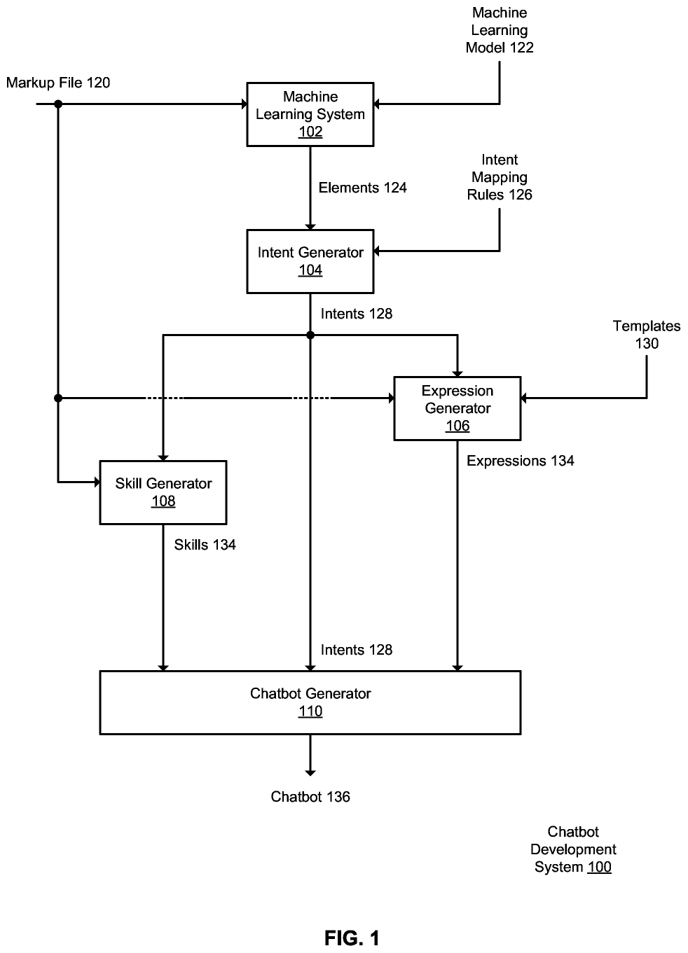

FIG. 1 is a block diagram of a chatbot development system 100. The chatbot development system 100 may be implemented by one or more computer systems, for example as controlled by one or more computer programs, as further detailed below. The chatbot development system 100 may include other components that (for brevity) are not discussed in detail. In general, the chatbot developer system 100 is used to generate a chatbot for a given webpage or other messaging channel; the user that develops the chatbot may be referred to as the “chatbot developer”. (The individuals who created the chatbot development system 100 may be referred to as the “system developers” or the “chatbot system developers”, and the individuals who use the chatbot created by the chatbot development system 100 may be referred to as the “end users”.) The chatbot development system 100 includes a machine learning system 102, an intent generator 104, an expression generator 106, a skill generator 108, and a chatbot generator 110.

The machine learning system 102 receives a markup language file 120 and performs a machine learning process on the markup language file 120 using a machine learning model 122 to identify one or more elements 124 in the markup language file. The markup language file 120 generally corresponds to the messaging channel and may be a HTML document, a webpage, an XML page, an OData file, etc. The machine learning model 122 generally corresponds to a model that has been developed offline by the chatbot system developers; the process of generating the machine learning model 122 is described in more detail below. The elements 124 generally correspond to user interface elements or other features of the markup language file 120 with which users may interact. The elements 124 may also be referred to as capabilities. Examples of the elements 124 include buttons, select boxes, interactive fields, text entry boxes, pull-down lists, sort buttons, etc. For example, a given webpage may display a list of products and prices, and may allow the user to perform actions such as requesting a display of all products with a price less than an entered amount.

In general, the machine learning system 102 uses the machine learning model 122 to perform pattern matching or other machine learning operations on the markup language file 120. The elements 124 then correspond to features in the markup language file 120 that the machine learning system 102 has identified as being relevant according to the machine learning model 122. For example, based on a general class of element defined in the machine learning model 122 (e.g., the genus), the machine learning system 102 identifies a specific instance of that element in the markup language file 120 (e.g., the species).

The machine learning system 102 provides the elements 124 to the intent generator 104.

The intent generator 104 applies intent mapping rules 126 to the elements 124 to generate intents 128. The intents 128 generally provide a context for the chatbot and form the heart of the chatbot's understanding. In general, each intent represents an idea the chatbot is able to understand, and each intent is associated with a functionality of the markup language file 120. For example, as part of generating a chatbot to understand when someone is asking for help, the intent generator 104 can generate an intent named “help”. The mapping rules 126 map elements to intents. For example, the machine learning system 102 may have identified a “help” button on the webpage and provided it with the elements 124; the intent generator 104 uses the mapping rules 126 to generate the corresponding “help” intent. The intent generator 104 provides the intents 128 to the expression generator 106, to the skill generator 108, and to the chatbot generator 110.

The expression generator 106 applies templates 130 to the intents 128 to generate expressions 132. The templates 120 provide a collection of expressions for a given intent. The templates 120 may be provided according to a service descriptor file. In general, an intent may be conceptualized as a box that contains a variety of expressions that have a similar meaning but are constructed in different ways, and an expression is a phrase that the chatbot can understand. In other words, the expression can represent a hypothetical end user input when interacting with the chatbot. Expressions are organized in intents and constitute the entire knowledge of the chatbot. The more expressions that are defined, the more precisely the chatbot will be able to understand the end users. For example, in the previous example, after the intent generator generates the intent for “help”, the expression generator 106 can associate the intent with a multitude of possible expressions the end user might enter when asking for help/guidance. Example expressions in such a case may include, “Can you help me”, “I am lost, give me a hand please”, “Can you help”, and “What can you do for me”.

In some implementations, a keyword can be extracted from an expression as an entity. For example, a service can be “create a leave request for tomorrow”; the extracted keyword can be “create”, the affected object is “leave request”, and the input parameter is the appropriate date of the following day (that is, “tomorrow”).

The expression generator 106 provides the expressions 132 to the chatbot generator 110.

The skill generator 108 generates skills 134 according based on the intents 128 and the markup language file 120. For each of the intents 128, the skill generator 108 generates a skill corresponding to the intent. The skill generator 108 may extract any actions associated with the skill and required data from the markup language file 120. In general, a skill corresponds to a block of conversation that has a clear purpose and that the chatbot can execute to achieve a goal. An example of a simple skill is the ability to greet the end user. An example of a complex still is to provide a list of movie suggestions based on parameters provided by the end user (e.g., genre, actors, starting time, etc.). In some implementations, a skill may include three distinct parts: 1) triggers, which are conditioned to determine if the skill should or should not be activated; 2) requirements that determine the information the chatbot needs to retrieve from the end user and the manner of retrieving it; and 3) actions, which are performed by the chatbot when the requirements are satisfied (for example, an action can be to expect an API call).

As another example, the skill corresponds to a data selection operation. Consider a webpage that displays a list of products and prices. The skill may be to display a subset of the products. For example, the end user input may be of the form “show me all <product> with <property name> less than <property value>”, where <product>, <property name> and <property value> are business objects extracted from the webpage; the skill generator 108 identifies the columns of the table on the webpage, corresponding to the product name and the price, as the appropriate business objects to associate with the skill. The skill then corresponds to displaying a subset of the products that have a price less than the user-provided amount.

The skill generator 108 provides the skills 134 to the chatbot generator 110.

The chatbot generator 110 generates a chatbot 136 based on the intents 128, the expressions 132 and the skills 134. For example, for the “help” intent, various expressions are associated based on the templates 130, as well as the skill to open a “help” dialogue box. The chatbot generator 110 may call a chatbot development service API to generate the chatbot 136. Once the chatbot generator 110 has generated the chatbot 136, the chatbot developer can interact with the generated chatbot 136 through an application UI. For example, the chatbot developer may review the associations of the intents 128, the expressions 132 and the skills 134 to ensure that the chatbot development system 100 has generated an appropriate chatbot 136 for the markup language file 120.

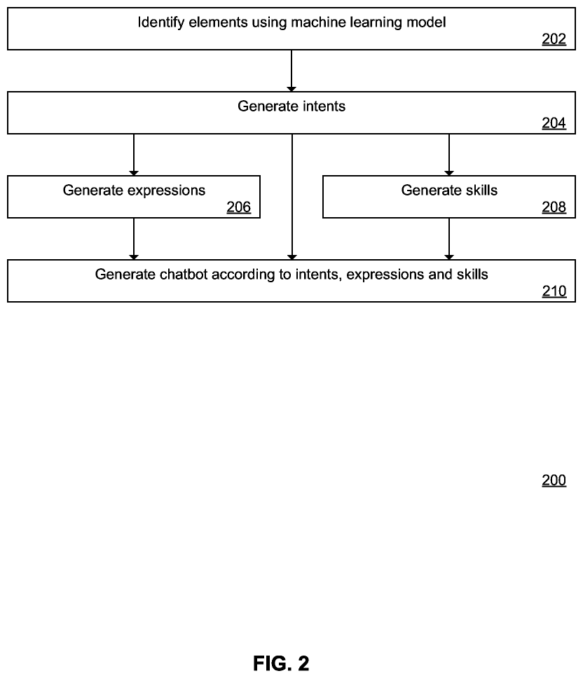

FIG. 2 is a flow diagram of a method 200 of generating a chatbot. The method 200 may be implemented by a computer system, for example as controlled by executing one or more computer programs, such as the chatbot development system 100 (see FIG. 1). The method 200 may include other steps that (for brevity) are not discussed in detail.

At 202, one or more elements of a markup language file are identified using a machine learning model. For example, the machine learning system 102 (see FIG. 1) may use the machine learning model 122 to identify the elements 124 in the markup language file 120.

At 204, for a given element of the one or more elements (see 202), one or more intents related to the given element are generated. The intents may be generated using intent mapping rules. For example, the intent generator 104 (see FIG. 1) may use the intent mapping rules 126 to generate the intents 128 for each of the elements 124. The step 204 may be performed for all the elements to generate sets of intents, with each set of one or more intents associated with a corresponding one of the elements.

At 206, for a given intent of the one or more intents (see 204), a number of expressions related to the given intent and the markup language file are generated. The expressions may be generated using templates. For example, the expression generator 106 (see FIG. 1) may use the templates 130 to generate the expressions 132 related to the intents 128 and the markup language file 120. The step 206 may be performed for all the intents to generate sets of expressions, with each set of expressions associated with a corresponding one of the intents.

At 208, for a given intent of the one or more intents (see 204), one or more skills related to the given intent and the markup language file are generated. For example, the skill generator 108 (see FIG. 1) may generate the skills 134 related to the intents 128 and the markup language file 120. The step 208 may be performed for all of the intents to generate sets of skills, with each set of skills associated with a corresponding one of the intents.

At 210, a chatbot is generated according to the intents, the expressions for each intent, and the skills for each intent. For example, the chatbot generator 110 (see FIG. 1) may generate the chatbot 136 according to the intents 129, the expressions 132 and the skills 134.

Once the chatbot has been created, the chatbot developer may connect the chatbot to various channels, for interaction with end users. For example, the channels may comprise chat-type platforms executing in web browsers or on mobile devices, such as Skype™ messaging, WhatsApp™ messaging, web browsers, etc.

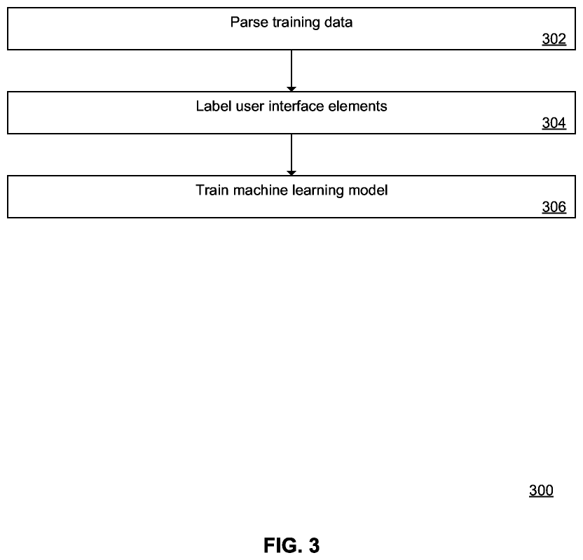

FIG. 3 is a flow diagram of a method 300 of training the machine learning model used by the chatbot development system 100 (see FIG. 1), e.g. the machine learning model 122. As discussed above, the chatbot development system 100 operates during the development phase and the machine learning model 122 is trained offline, e.g. in a training phase prior to the development phase.

At 302, a plurality of training data is parsed by a machine learning system to identify a plurality of user interface elements. The training data corresponds to a number of markup language files such as webpages, HTML files, etc. The user interface elements correspond to buttons, tables, actions, filters, etc. For example, the system developer may provide a number of webpages to a computer system, which parses the webpages to identify the user interface elements.

At 304, the user interface elements identified in 302 are labeled according to an element category. The system developer may perform the labeling. For example, when the computer system has identified 5 user interface elements (see 302), the system developer may label them using the category of button, table, action, filter, etc. Labeling the elements can be a time intensive process. A large data set of labeled elements improves the machine learning model by providing more examples of specific user interface elements that may appear on webpages. In addition, accurately labeling the elements during the training phase improves the machine learning model as well. Thus, by investing the time during the training phase, the improved results and performance during the development phase may provide an aggregate time savings.

At 306, the machine learning model is generated by the machine learning system by training the machine learning model according to the plurality of labeled user interface elements (see 304). For example, the computer system may implement a machine learning system that trains the machine learning model 122 using the training data that contains the labeled user interface elements. The machine learning system may implement one or more machine learning processes, including artificial neural networks, support vector machines, etc.

The method 300 may be used to generate a number of machine learning models, where each model corresponds to a given language (e.g., English, German, Japanese, etc.). In such a case, the training data for a given language is selected, and that subset of training data is used to train the corresponding model for the given language. Then during the development phase (see FIG. 2), the chatbot developer may select the appropriate model according to the desired language of the channel to which the chatbot is to be connected.

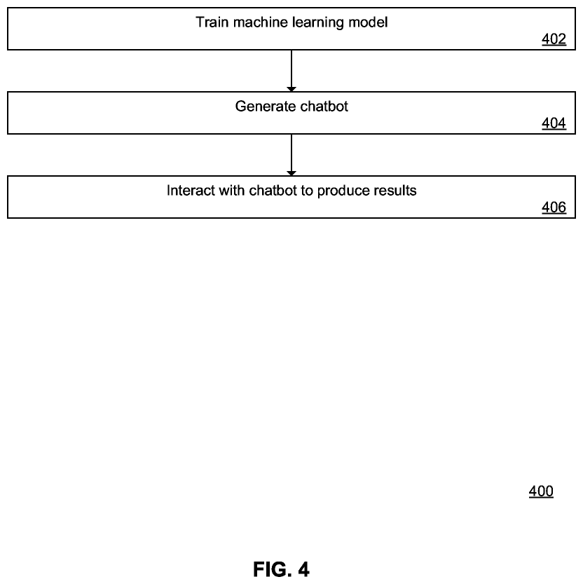

FIG. 4 is a flow diagram of a method 400 of using a chatbot. The method 400 shows the overall lifecycle of the chatbot process, and includes the functions of system development, training, chatbot development, and end use. The method 400 may be implemented using one or more computer systems.

At 402, a machine learning model is generated and trained. In general, the step 402 corresponds to the steps of the method 300 (see FIG. 3), performed in a training phase by system developers using a system development environment. For example, Company X may train the machine learning model, may create a chatbot development system (e.g., the chatbot development system 100 of FIG. 1), and may integrate the machine learning model as part of the chatbot development system. Furthermore, Company X may periodically update or re-train the machine learning model, for example to account for additional types of user interface elements.

At 404, a chatbot is generated using the chatbot development system. In general, the step 404 corresponds to the steps of the method 200 (see FIG. 2), performed in a development phase by the chatbot developer using the chatbot development system (e.g., the chatbot development system 100 of FIG. 1). For example, Company Y may purchase the chatbot development system from Company X (or may access the chatbot development system as a service provided by Company X), and Company Y may generate chatbots using the chatbot development system.

At 406, a user interaction occurs with the chatbot to generate user interaction results. In general, the step 406 corresponds to an end user interacting with the chatbot in the associated communication channel. For example, the end user may interact with a chatbot in a WhatsApp™ application to generate a list of upcoming movies, in response to user input.

### Advantages

As discussed above, the chatbot development systems described herein may provide a number of advantages as compared to existing systems. One advantage is that the machine learning model provides time savings in identifying the elements for the chatbot, as compared to manually identifying each element on the webpage.

Another advantage relates to time savings for multi-language chatbot development. Once a chatbot has been developed for a webpage in one language (e.g., English), the process may be repeated for webpages in other languages (e.g., German, Japanese, etc.). The different machine learning models for each language allow easy identification of the user interface elements, and the expressions and templates used for the chatbot in the first language may be easily corresponded with the expressions and templates used for the chatbots in the additional languages.

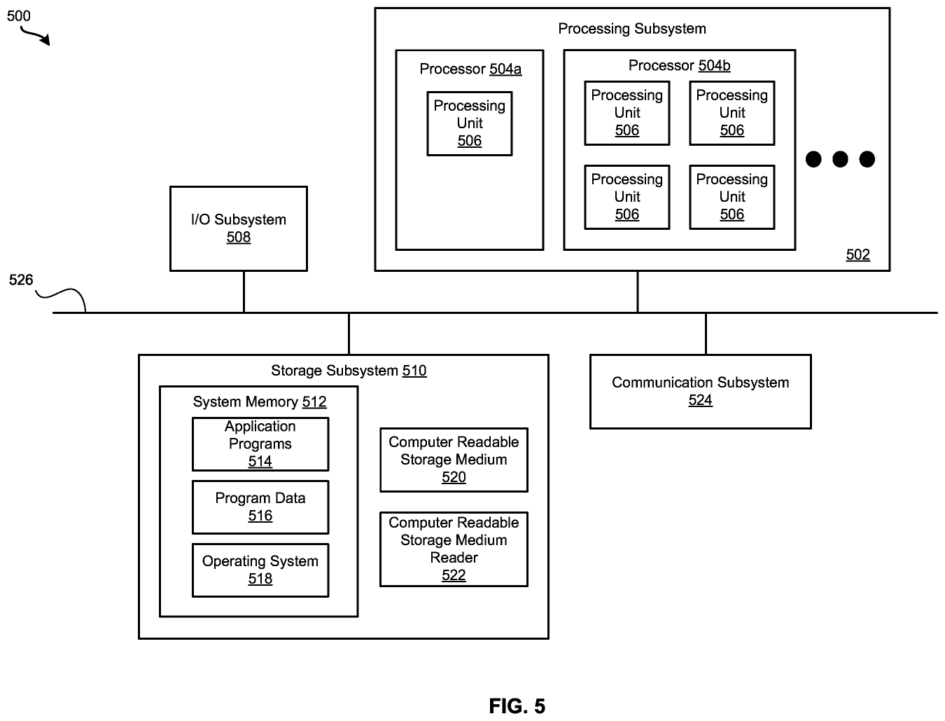

FIG. 5 is a block diagram of an example computer system 500 for implementing various embodiments described above. For example, the computer system 500 may be used to implement the chatbot development system 100 (see FIG. 1), etc. The computer system 500 may be a desktop computer, a laptop, a server computer, or any other type of computer system or combination thereof. Some or all elements of the machine learning system 102, the intent generator 104, the expression generator 106, the skill generator 108, the chatbot generator 110, etc. or combinations thereof can be included or implemented in the computer system 500. In addition, the computer system 500 can implement many of the operations, methods, and/or processes described above (e.g., the method 200 of generating a chatbot of FIG. 2, the method 300 of training the machine learning model of FIG. 3, etc.). As shown in FIG. 5, the computer system 500 includes a processing subsystem 502, which communicates, via a bus subsystem 526, with an input/output (I/O) subsystem 508, a storage subsystem 510 and a communication subsystem 524.

The bus subsystem 526 is configured to facilitate communication among the various components and subsystems of the computer system 500. While the bus subsystem 526 is illustrated in FIG. 5 as a single bus, one of ordinary skill in the art will understand that the bus subsystem 526 may be implemented as multiple buses. The bus subsystem 526 may be any of several types of bus structures (e.g., a memory bus or memory controller, a peripheral bus, a local bus, etc.) using any of a variety of bus architectures. Examples of bus architectures may include an Industry Standard Architecture (ISA) bus, a Micro Channel Architecture (MCA) bus, an Enhanced ISA (EISA) bus, a Video Electronics Standards Association (VESA) local bus, a Peripheral Component Interconnect (PCI) bus, a Universal Serial Bus (USB), etc.

The processing subsystem 502, which can be implemented as one or more integrated circuits (e.g., a conventional microprocessor or microcontroller), controls the operation of the computer system 500. The processing subsystem 502 may include one or more processors 504. Each processor 504 may include one processing unit 506 (e.g., a single core processor such as the processor 504a) or several processing units 506 (e.g., a multicore processor such as the processor 504b). In some embodiments, the processors 504 of the processing subsystem 502 may be implemented as independent processors while, in other embodiments, the processors 504 of the processing subsystem 502 may be implemented as multiple processors integrate into a single chip or multiple chips. Still, in some embodiments, the processors 504 of the processing subsystem 502 may be implemented as a combination of independent processors and multiple processors integrated into a single chip or multiple chips.

In some embodiments, the processing subsystem 502 may execute a variety of programs or processes in response to program code and can maintain multiple concurrently executing programs or processes. At any given time, some or all of the program code to be executed may reside in the processing subsystem 502 or in the storage subsystem 510. Through suitable programming, the processing subsystem 502 may provide various functionalities, such as the functionalities described above by reference to the method 200 (see FIG. 2), the method 300 (see FIG. 3), etc.

The 110 subsystem 508 may include any number of user interface input devices and/or user interface output devices. User interface input devices may include a keyboard, pointing devices (e.g., a mouse, a trackball, etc.), a touchpad, a touch screen incorporated into a display, a scroll wheel, a click wheel, a dial, a button, a switch, a keypad, audio input devices with voice recognition systems, microphones, image/video capture devices (e.g., webcams, image scanners, barcode readers, etc.), motion sensing devices, gesture recognition devices, eye gesture (e.g., blinking) recognition devices, biometric input devices, or other types of input devices.

User interface output devices may include visual output devices (e.g., a display subsystem, indicator lights, etc.), audio output devices (e.g., speakers, headphones, etc.), etc. Examples of a display subsystem may include a cathode ray tube (CRT), a flat-panel device (e.g., a liquid crystal display (LCD), a plasma display, etc.), a projection device, a touch screen, or other types of devices and mechanisms for outputting information from the computer system 500 to a user or another device (e.g., a printer).

As illustrated in FIG. 5, the storage subsystem 510 includes a system memory 512, a computer-readable storage medium 520, and a computer-readable storage medium reader 522. The storage subsystem 510 may implement the storage for the machine learning model 122, the intent mapping rules 126, the templates 130, etc. The system memory 512 may be configured to store software in the form of program instructions that are loadable and executable by the processing subsystem 502 as well as data generated during the execution of program instructions. In some embodiments, the system memory 512 may include volatile memory (e.g., random access memory (RAM)) and/or non-volatile memory (e.g., read-only memory (ROM), programmable read-only memory (PROM), erasable programmable read-only memory (EPROM), electrically erasable programmable read-only memory (EEPROM), flash memory, etc.). The system memory 512 may include different types of memory, such as static random access memory (SRAM) and/or dynamic random access memory (DRAM). The system memory 512 may include a basic input/output system (BIOS), in some embodiments, that is configured to store basic routines to facilitate transferring information between elements within the computer system 500 (e.g., during start-up). Such a BIOS may be stored in ROM (e.g., a ROM chip), flash memory, or another type of memory that may be configured to store the BIOS.

As shown in FIG. 5, the system memory 512 includes application programs 514 (e.g., that implement the chatbot development system 100), program data 516, and operating system (OS) 518. The OS 518 may be one of various versions of Microsoft Windows™, Apple Mac OS™, Apple OS X™, Apple macOS™, and/or Linux™ operating systems, a variety of commercially-available UNIX™ or UNIX-like operating systems (including without limitation the variety of GNU/Linux operating systems, the Google Chrome™ OS, and the like) and/or mobile operating systems such as Apple iOS™, Windows Phone™ Windows Mobile™, Android™, BlackBerry OS™, Blackberry 10™, Palm OS™, and WebOS™ operating systems.

The computer-readable storage medium 520 may be a non-transitory computer-readable medium configured to store software (e.g., programs, code modules, data constructs, instructions, etc.). Many of the components (e.g., the chatbot development system 100, etc.) or processes (e.g., the method 200, the method 300, etc.) described above may be implemented as software that when executed by a processor or processing unit (e.g., a processor or processing unit of the processing subsystem 502) performs the operations of such components and/or processes. The storage subsystem 510 may also store data used for, or generated during, the execution of the software.

The storage subsystem 510 may also include the computer-readable storage medium reader 522 that is configured to communicate with the computer-readable storage medium 520. Together and, optionally, in combination with the system memory 512, the computer-readable storage medium 520 may comprehensively represent remote, local, fixed, and/or removable storage devices plus storage media for temporarily and/or more permanently containing, storing, transmitting, and retrieving computer-readable information.

The computer-readable storage medium 520 may be any appropriate media known or used in the art, including storage media such as volatile, non-volatile, removable, non-removable media implemented in any method or technology for storage and/or transmission of information. Examples of such storage media includes RAM, ROM, EEPROM, flash memory or other memory technology, compact disc read-only memory (CD-ROM), digital versatile disk (DVD), Blu-ray Disc (BD), magnetic cassettes, magnetic tape, magnetic disk storage (e.g., hard disk drives), Zip drives, solid-state drives (SSD), flash memory card (e.g., secure digital (SD) cards, CompactFlash cards, etc.), USB flash drives, or other types of computer-readable storage media or device.

The communication subsystem 524 serves as an interface for receiving data from, and transmitting data to, other devices, computer systems, and networks. For example, the communication subsystem 524 may allow the computer system 500 to connect to one or more devices via a network (e.g., a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.). The communication subsystem 524 can include any number of different communication components. Examples of such components may include radio frequency (RF) transceiver components for accessing wireless voice and/or data networks (e.g., using cellular technologies such as 2G, 3G, 4G, 5G, etc., wireless data technologies such as Wi-Fi, Bluetooth™, ZigBee™, etc., or any combination thereof), global positioning system (GPS) receiver components, or other components. In some embodiments, the communication subsystem 524 may provide components configured for wired communication (e.g., Ethernet) in addition to or instead of components configured for wireless communication.

One of ordinary skill in the art will realize that the architecture shown in FIG. 5 is only an example architecture of the computer system 500, and that the computer system 500 may have additional or fewer components than shown, or a different configuration of components. The various components shown in FIG. 5 may be implemented in hardware, software, firmware or any combination thereof, including one or more signal processing and/or application specific integrated circuits.

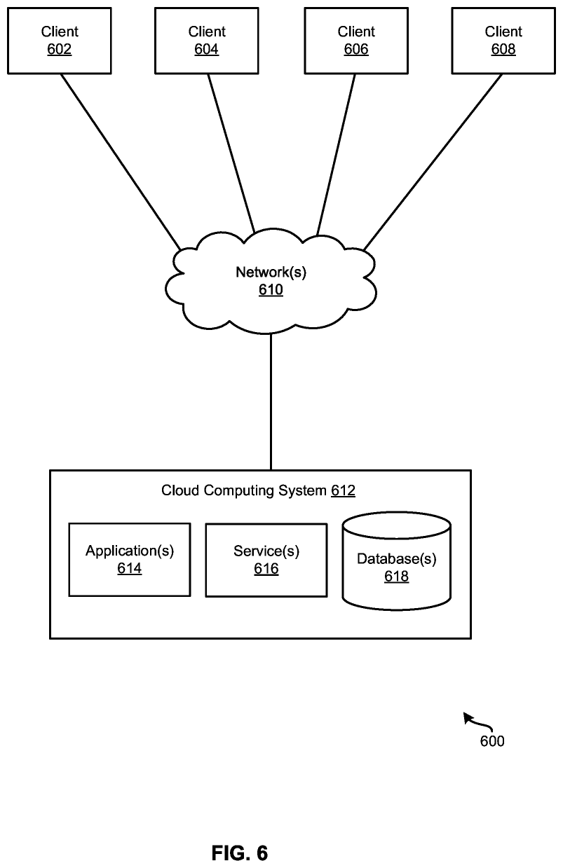

FIG. 6 is a block diagram of a cloud computing system 600 for implementing various embodiments described above. For example, one of the client devices 602-608 may be used to implement a client device for accessing the chatbot by an end user (see 406 in FIG. 4), a cloud computing system 612 of the system 600 may be used to implement the chatbot development system 100, and another of the client devices 602-608 may be used by the chatbot developer to create the chatbot (see 404 in FIG. 4), etc. As shown, the system 600 includes the client devices 602-608, one or more networks 610, and the cloud computing system 612. The cloud computing system 612 is configured to provide resources and data to the client devices 602-608 via the networks 610. In some embodiments, the cloud computing system 600 provides resources to any number of different users (e.g., customers, tenants, organizations, etc.). The cloud computing system 612 may be implemented by one or more computer systems (e.g., servers), virtual machines operating on a computer system, or a combination thereof.

As shown, the cloud computing system 612 includes one or more applications 614, one or more services 616, and one or more databases 618. The cloud computing system 600 may provide the applications 614, services 616, and databases 618 to any number of different customers in a self-service, subscription-based, elastically scalable, reliable, highly available, and secure manner.

In some embodiments, the cloud computing system 600 may be adapted to automatically provision, manage, and track a customer's subscriptions to services offered by the cloud computing system 600. The cloud computing system 600 may provide cloud services via different deployment models. For example, cloud services may be provided under a public cloud model in which the cloud computing system 600 is owned by an organization selling cloud services and the cloud services are made available to the general public or different industry enterprises. As another example, cloud services may be provided under a private cloud model in which the cloud computing system 600 is operated solely for a single organization and may provide cloud services for one or more entities within the organization. The cloud services may also be provided under a community cloud model in which the cloud computing system 600 and the cloud services provided by the cloud computing system 600 are shared by several organizations in a related community. The cloud services may also be provided under a hybrid cloud model, which is a combination of two or more of the aforementioned different models.

In some instances, any one of the applications 614, services 616, and databases 618 made available to the client devices 602-608 via the networks 610 from the cloud computing system 600 is referred to as a “cloud service”. Typically, servers and systems that make up the cloud computing system 600 are different from the on-premises servers and systems of a customer. For example, the cloud computing system 600 may host an application and a user of one of client devices 602-608 may order and use the application via the networks 610.

The applications 614 may include software applications that are configured to execute on the cloud computing system 612 (e.g., a computer system or a virtual machine operating on a computer system) and be accessed, controlled, managed, etc. via the client devices 602-608. In some embodiments, the applications 614 may include server applications and/or mid-tier applications (e.g., HTTP (hypertext transport protocol) server applications, FTP (file transfer protocol) server applications, CGI (common gateway interface) server applications, Java™ server applications, etc.). The services 616 are software components, modules, application, etc. that are configured to execute on the cloud computing system 612 and provide functionalities to the client devices 602-608 via the networks 610. The services 616 may be web-based services or on-demand cloud services.

The databases 618 are configured to store and/or manage data that is accessed by the applications 614, the services 616, or the client devices 602-608. For instance, the machine learning model 122, the intent mapping rules 126, the templates 130, etc. may be stored in the databases 618. The databases 618 may reside on a non-transitory storage medium local to (and/or resident in) the cloud computing system 612, in a storage-area network (SAN), or on a non-transitory storage medium local located remotely from the cloud computing system 612. In some embodiments, the databases 618 may relational databases that are managed by a relational database management system (RDBMS), etc. The databases 618 may be a column-oriented databases, row-oriented databases, or a combination thereof. In some embodiments, some or all of the databases 618 are in-memory databases. That is, in some such embodiments, data for the databases 618 are stored and managed in memory (e.g., random access memory (RAM)).

The client devices 602-608 are configured to execute and operate a client application (e.g., a web browser, a proprietary client application, etc.) that communicates with the applications 614, services 1716, or databases 618 via the networks 610. This way, the client devices 602-608 may access the various functionalities provided by the applications 614, services 616, and databases 618 while the applications 614, services 616, and databases 618 are operating (e.g., hosted) on the cloud computing system 600. The client devices 602-608 may be the computer system 500 (see FIG. 5). Although the system 600 is shown with four client devices, any number of client devices may be supported.

The networks 610 may be any type of network configured to facilitate data communications among the client devices 602-608 and the cloud computing system 612 using any of a variety of network protocols. The networks 610 may be a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computer implemented method of generating chatbots, the method comprising:
identifying, by a computer system, one or more elements of a markup language file using a machine learning model;
for a given element of the one or more elements:
generating, by the computer system, one or more intents related to the given element;
for a given intent of the one or more intents:
generating, by the computer system, a plurality of expressions related to the given intent and the markup language file;
generating, by the computer system, one or more skills related to the given intent and the markup language file; and
generating, by the computer system, a chatbot according to the one or more intents, the plurality of expressions for each intent of the one or more intents, and the one or more skills for each intent of the one or more intents.

2. The method of claim 1, further comprising:
parsing, by a machine learning system, a plurality of training data to identify a plurality of user interface elements, wherein the plurality of training data includes a plurality of markup language files;
labeling each of the plurality of user interface elements according to an element category to generate a plurality of labeled user interface elements; and
generating, by the machine learning system, the machine learning model by training the machine learning model according to the plurality of labeled user interface elements.

3. The method of claim 2, wherein the plurality of markup language files has a plurality of languages;
wherein the plurality of labeled user interface elements is grouped into a plurality of groups corresponding to the plurality of languages; and
wherein the machine learning system generates a plurality of machine learning models according to the plurality of groups, wherein a given machine learning model of the plurality of machine learning models corresponds to one group of the plurality of groups and to one language of the plurality of languages.

4. The method of claim 1, wherein the given intent is associated with a functionality of the markup language file.

5. The method of claim 1, wherein the one or more intents related to the given element are generated according to intent mapping rules, wherein the intent mapping rules map a set of user interface elements to a set of intents.

6. The method of claim 1, wherein the plurality of expressions correspond to a set of phrases that the chatbot is able to understand.

7. The method of claim 1, wherein the plurality of expressions related to the given intent and the markup language file is generated according to a template, wherein the template maps the plurality of expressions in a set of expressions to the given intent.

8. The method of claim 1, wherein the one or more skills correspond to a block of conversation that has a defined purpose and that the chatbot can execute to achieve a goal.

9. The method of claim 1, wherein a given skill of the one or more skills includes at least one trigger, at least one requirement, and at least one action;
wherein the at least one trigger corresponds to a condition that determines whether or not the skill is activated;
wherein the at least one requirement corresponds to information that the chatbot needs to retrieve from the end user and a manner of retrieving the information; and
wherein the at least one action is performed when the at least one requirement is satisfied.

10. The method of claim 1, further comprising:
connecting the chatbot to at least one channel.

11. The method of claim 1, further comprising:
receiving, from an end user, a user interaction with the chatbot; and
outputting, by the chatbot, a result of the user interaction according to the one or more skills.

12. A non-transitory computer readable medium storing instructions that, when executed by a processor of a computer system, control the computer system to perform a method of generating chatbots, the method comprising:
identifying, by a computer system, one or more elements of a markup language file using a machine learning model;
for a given element of the one or more elements:
generating, by the computer system, one or more intents related to the given element;
for a given intent of the one or more intents:
generating, by the computer system, a plurality of expressions related to the given intent and the markup language file;
generating, by the computer system, one or more skills related to the given intent and the markup language file; and
generating, by the computer system, a chatbot according to the one or more intents, the plurality of expressions for each intent of the one or more intents, and the one or more skills for each intent of the one or more intents.

13. A computer system for generating chatbots, the computer system comprising:
a memory; and
a processor,
wherein the processor is configured to control the computer system to identify one or more elements of a markup language file using a machine learning model;
wherein for a given element of the one or more elements:
the processor is configured to control the computer system to generate one or more intents related to the given element;
wherein for a given intent of the one or more intents:
the processor is configured to control the computer system to generate a plurality of expressions related to the given intent and the markup language file;
the processor is configured to control the computer system to generate one or more skills related to the given intent and the markup language file; and
wherein the processor is configured to control the computer system to generate a chatbot according to the one or more intents, the plurality of expressions for each intent of the one or more intents, and the one or more skills for each intent of the one or more intents.

14. The computer system of claim 13, further comprising:
a machine learning system,
wherein the machine learning system is configured to parse a plurality of training data to identify a plurality of user interface elements, wherein the plurality of training data includes a plurality of markup language files,
wherein the computer system is configured to label each of the plurality of user interface elements according to an element category to generate a plurality of labeled user interface elements, and
wherein the machine learning system is configured to generate the machine learning model by training the machine learning model according to the plurality of labeled user interface elements.

15. The computer system of claim 14, wherein the plurality of markup language files has a plurality of languages;
wherein the plurality of labeled user interface elements is grouped into a plurality of groups corresponding to the plurality of languages; and
wherein the machine learning system generates a plurality of machine learning models according to the plurality of groups, wherein a given machine learning model of the plurality of machine learning models corresponds to one group of the plurality of groups and to one language of the plurality of languages.

16. The computer system of claim 13, wherein the one or more intents related to the given element are generated according to intent mapping rules, wherein the intent mapping rules map a set of user interface elements to a set of intents.

17. The computer system of claim 13, wherein the plurality of expressions related to the given intent and the markup language file is generated according to a template, wherein the template maps the plurality of expressions in a set of expressions to the given intent.

18. The computer system of claim 13, wherein a given skill of the one or more skills includes at least one trigger, at least one requirement, and at least one action;
wherein the at least one trigger corresponds to a condition that determines whether or not the skill is activated;
wherein the at least one requirement corresponds to information that the chatbot needs to retrieve from the end user and a manner of retrieving the information; and
wherein the at least one action is performed when the at least one requirement is satisfied.

19. The computer system of claim 13, wherein the processor is configured to control the computer system to connect the chatbot to at least one channel.

20. The computer system of claim 13, wherein the processor is configured to control the computer system to receive, from an end user, a user interaction with the chatbot, and
wherein the processor is configured to control the computer system to output, by the chatbot, a result of the user interaction according to the one or more skills.
